(19) United States
(12) Patent Application Publication
(10) Pub. No.: US 2005/0168781 A1
(43) Pub. Date: Aug. 4, 2005

(54) Photographic printing system and method of making photographic print

(76) Inventors: Atsushi Nagamatsu, Wakayama-ken (JP); Nobuhiro Tsujioka, Wakayama-ken (JP)

Correspondence Address: FULBRIGHT & JAWORSKI, LLP, 666 FIFTH AVE, NEW YORK, NY, 10103-3198, US

(21) Appl. No.: 11/039,134

(22) Filed: Jan. 18, 2005

(30) Foreign Application Priority Data
Jan. 19, 2004 (JP) PAT. 2004-10155

(51) Int. Cl. G06K 15/02; G06F 3/12

(52) U.S. Cl. 358/1.18; 358/1.15

(57) ABSTRACT

A photographic printing system includes an input unit for inputting an image for making a photographic print thereof from an image storage medium storing the image in the form of an image file, a photographic printer for making the photographic print based on the image inputted by the input unit and a writer unit for writing image data of the image from which the photographic print has been made, into a recording medium. The writer unit writes into the recording medium a file name assigned to the image data when recorded in the image storage medium, either as an information file separate from and in correlation with the image file or as a portion of the data of the image file.

### BACKGROUND OF THE INVENTION

1. Field of the Invention

The present invention relates to a photographic printing system including an input unit for inputting an image for making a photographic print thereof from an image storage medium storing the image in the form of a file, a photographic printer for making the photographic print based on the image inputted by the input unit, and a writer unit for writing image data of the image from which the photographic print has been made, into a recording medium.

The present invention relates also to a method of making a photographic print, including the steps of inputting an image for making a photographic print thereof from an image storage medium storing the image in the form of a file, making the photographic print based on the image inputted by the input unit, and writing image data of the image from which the photographic print has been made, into a recording medium.

2. Description of the Related Art

A specific example of such photographic printing system described above is a so-called “mini-lab” which is a system installed in a photographic processing shop or lab for making a photographic print based on an image recorded by e.g. a digital camera. In the case of this photographic printing system, as described also in Japanese Patent Application “Kokai” No. 11-88577, there is provided a service for the customer for recording image data from which photographic prints were made into a recording medium such as a CD-R and providing this recording medium together with the photographic prints to the customer. Later, the customer can bring this recording medium to a photo shop to place an order for reprint based thereon.

However, with the conventional system described above, there can occur a confusion with respect to handling of such reprint order from a customer.

Namely, when a customer brings a recording medium such as a CD-R to a photo shop and places a reprint order, the customer often specifies an image to be reprinted by way of its image file name printed on the back face of the photographic print. However, this image file name printed on the back face of the photographic print is an image file name on the image storage medium (meaning e.g. a memory card taken out of a digital camera used for the photography) from which the photographic prints were made at the time of the customer's placing the previous print order, hence being different from its image file name on the recording medium (CD-R). Then, the shop attendant cannot determine for which image the customer is requesting its reprint. The disagreement occurs due to the fact that the file name of the image data recorded in the recording medium is produced independently of the file name of the image file stored in the image storage medium.

Therefore, when the customer has placed a reprint order by way of the image file name on the original image storage medium, the operator (e.g. a shop attendant) of the photographic printing system needs to cause the images recorded in the recording medium to be displayed on a monitor installed at the shop to enable visual comparative confirmation of the images to be reprinted by comparison thereof with the photographic prints. Or the operator needs to cause the images recorded in the recording medium to be displayed on the monitor to allow the customer to specify the images for which the customer desires reprints. Moreover, in case a plurality of similar images are included in one order, such visual comparative confirmation on the images to be reprinted can be difficult, tending to result in an erroneous specification of an images to be reprinted.

### SUMMARY OF THE INVENTION

The present invention has been made in view of the above-described state of the art. A primary object of the present invention is to provide a photographic printing system and a method of making a photographic print which system or method allows a photo shop attendant, when receiving a customer's order for reprint based on a recording medium such as a CD-R, to easily identify an image to be reprinted by way of its image file name.

For fulfilling the above-noted object, according to the first feature of the invention, a photographic printing system comprises:
an input unit for inputting an image for making a photographic print thereof from an image storage medium storing the image in the form of an image file;
a photographic printer for making the photographic print based on the image inputted by the input unit; and
a writer unit for writing image data of the image from which the photographic print has been made, into a recording medium;
wherein said writer unit writes into the recording medium a file name assigned to the image data when recorded in the image storage medium, either as an information file separate from and with correlation with said image file or as a portion of the data of said image file.

Therefore, when receiving a customer's order for reprint based on a storage medium such as a CD-R, the operator of the photographic printing system can easily identify the image to be reprinted by reading, if needed, its original file name, from that recording medium, that is, its image file name in the original image storage medium. In other words, the operator can obtain the image file name in the original image storage medium in correlation thereof with the image recorded in the recording medium. In this way, the operator can easily identify the image to be reprinted by way of its original file name (recorded in the image storage medium).

According to the second feature of the present invention, in addition to the first feature described above, said recording medium comprises a CD-R medium.

Namely, the CD-R medium, which is a medium not allowing physical deletion of data once recorded therein or rewriting thereof with new data, is generally available at low costs. Then, the service of providing a recording medium recording image data therein can be provided as low costs to customers.

Then, the image data providing service and reprint order receiving service can be effected by taking advantage of this inexpensive medium. And, in doing these, when receiving a customer's reprint order by way of image file name in the original image storage medium, the operator can easily and reliably identify the image to be reprinted by utilizing its original file name recorded in the recording medium, i.e. the CD-R.

Further, with the second feature, in addition to the possibility of providing the customer with image data from which photographic prints were made, by using the inexpensive medium, customer's order for reprint can be processed smoothly.

According to a third feature of the present invention, there is proposed a method of making a photographic print, comprising the steps of:
inputting an image for making a photographic print thereof from an image storage medium storing the image in the form of an image file;
making the photographic print based on the image inputted by the input unit; and
writing image data of the image from which the photographic print has been made, into a recording medium;
wherein at said writing step, a file name assigned to the image data when recorded in the image storage medium is written in the recording medium either as an information file separate from and with correlation with said image file or as a portion of the data of said image file.

Therefore, when receiving a customer's order for reprint based on a storage medium such as a CD-R, e.g. the operator of the photographic printing system can easily identify the image to be reprinted by inputting, if needed, its original file name, from that recording medium, that is, its image file name in the original image storage medium. In other words, the operator can obtain the image file name in the original image storage medium with correlation thereof with the image recorded in the recording medium. In this way, the operator can easily identify the image to be reprinted by way of its original file name (recorded in the image storage medium).

Further and other features of the invention will become apparent upon reading the following detailed description of preferred embodiments thereof with reference to the accompanying drawings.

### BRIEF DESCRIPTION OF THE DRAWINGS

FIG. 1 is a block diagram of a photographic printing system relating to one preferred embodiment of the present invention,

FIG. 2 shows an exemplary layout of the photographic printing system at a shop or the like,

FIG. 3 is a flowchart relating to the embodiment,

FIG. 4 is another flowchart relating to the embodiment,

FIG. 5 is a view showing an exemplary operation assisting screen relating to the embodiment, and

FIG. 6 is another view showing an exemplary operation assisting screen relating to the embodiment.

### DESCRIPTION OF THE PREFERRED EMBODIMENTS

Preferred embodiments of a photographic printing system relating to the present invention will be described with reference to the accompanying drawings.

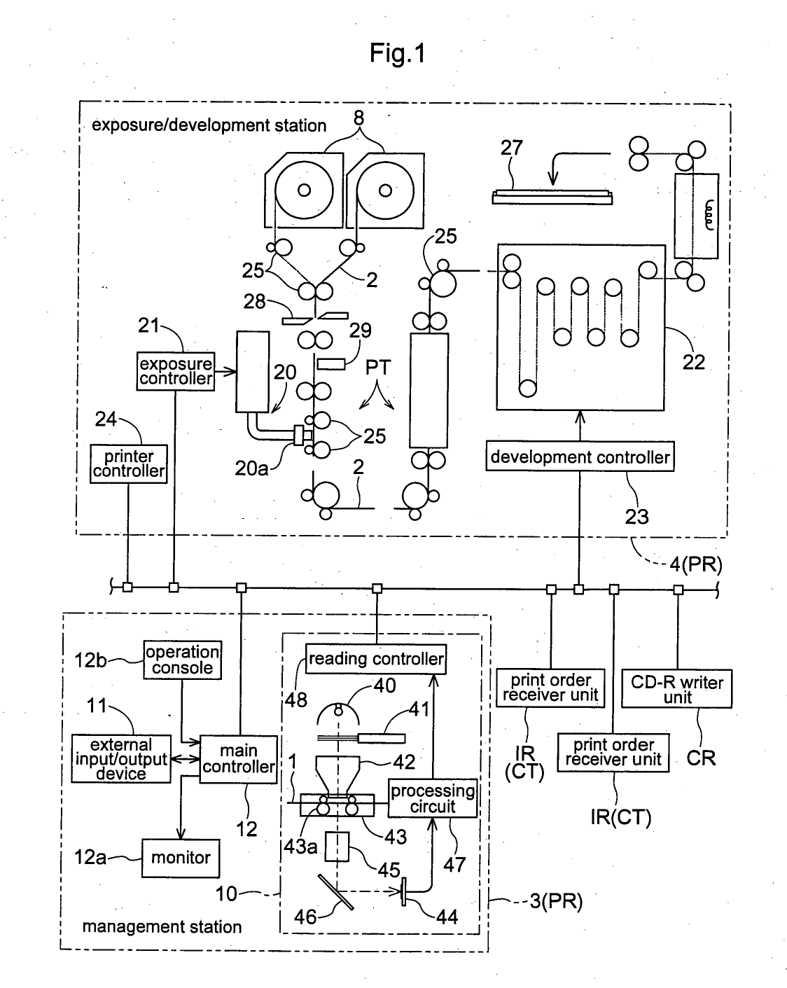

A photographic printing system DP shown in FIG. 1 is known generally as “digital mini lab”. The system includes a print order receiver unit IR for receiving a customer's order for making photographic print by inputting image data from various image storage media such as a memory card, a magneto-optical disk, a CD-R etc., a photographic printer PR for making a photographic print based on the image data inputted via the print order receiver unit IR or image data inputted from a developed photographic film, and a writer unit CR for writing the image data from which the photographic print has been made into a recording medium such as a CD-R. The above-listed components of the system are operably coupled with each other via a network.

In the instant embodiment, as an example of the recording medium into which the writer unit CR writes image data, there is employed a CD-R medium which is one example of non-rewritable recording media. Hence, in the following discussion, the writer unit CR will be referred to as the CD-R writer unit CR.

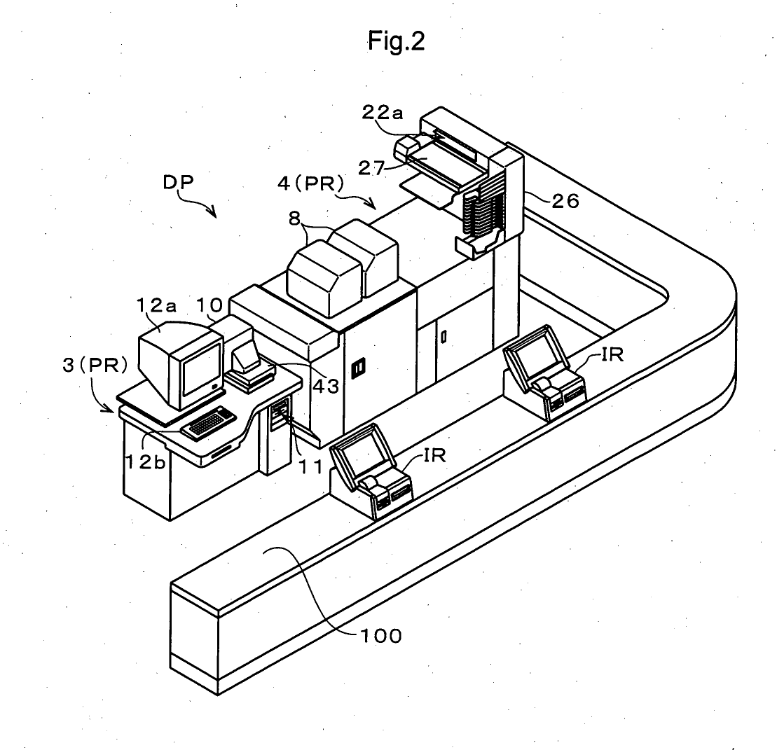

FIG. 2 shows an exemplary layout of the photographic printing system DP at a “mini lab” shop. In this case, the shop is equipped with two such print order receiver units IR mounted on a counter 100 for allowing self-operation by a customer. For simplicity of illustration, the writer unit CR is not shown in this FIG. 2.

[General Construction of Print Order Receiver Unit IR]

The print order receiver unit IR includes a CD-ROM drive for reading image data recorded in a CD-R medium, an MO drive for reading image data recorded in a magneto-optic disk, a memory card reader for reading image data recorded in memory cards of various designs available in the market, and a touch-panel type monitor for displaying guidance information to a customer for his/her placing a print order. Further, though not shown, the print order receiver unit IR includes a controller for controlling the above-described components thereof.

[General Construction of Photographic Printer PR]

The photographic printer PR, as shown in FIGS. 1 and 2, includes, a management station 3 having a film scanner 10 for reading frame images of the developed photographic film 1 and configured for managing overall operations of the photographic printing system DP, and an exposure/development station 4 for making photographic prints by effecting exposure and development on print papers 2 based on the image data to be exposed received from the management station 3.

[Construction of Management Station 3]

The management station 3, as shown schematically in the block diagram of FIG. 1, includes the film scanner 10 for reading frame images of the developed photographic film 1, an external input/output device 11 having the memory card reader, the MO drive, the CD-R drive etc., and a main controller 12 comprising a general-purpose computer system and configured for controlling the film scanner 10 and the external input/output device 11 and controlling also the entire photographic printing system DP. The main controller 12 is operably connected with a monitor 12a for displaying a simulated image simulating a finished print and various kinds of control information and an operation console 12b for allowing e.g. manual setting of exposure conditions and inputs of control information.

The film scanner 10 includes a halogen lamp 40, a light modulating filter 41 for balancing color components contained in a beam emitted from the halogen lamp 40, a mirror tunnel 42 for uniformly mixing the color components of the beam transmitted through the light modulating filter 41, a film carrier 43 having a conveying mechanism 43a, etc. and configured for setting the film 1 at a predetermined reading position, a CCD line sensor unit 44 for effecting photoelectric conversion of each frame image of the film 1, a lens 45 for focusing each frame image of the film 1 on the CCD line sensor unit 44, a mirror 46 for flexing an optical path by 90 degrees, a processing circuit 47 for effecting amplification and A/D conversion etc. of output signals from the CCD line sensor unit 44, and a reading controller 48 for controlling the entire film scanner 10.

The CCD line sensor unit 44 includes three arrays of CCD line sensors juxtaposed along the width of the film 1, each line sensor having about 5000 units of CCD elements. In beam receiving faces of the respective arrays of CCD line sensors, red, green and blue color filters are formed for separating and detecting the color components of the frame image of the film 1 respectively.

Upon receipt of a reading instruction from the main controller 12, the reading controller 48 causes the film carrier 43 to initiate conveying of the film 1 set thereto and also outputs image data of each frame image outputted from the processing circuit 47 to the main controller 12.

Though not shown, the main controller 12 includes an image processing apparatus for processing the image data of the frame image of the film 1, the image data inputted via the external input/output device 11 or the image data inputted via the print order receiver unit IR into an image suitable for making a photographic print and generating image data to be exposed.

[General Construction of Exposure/Development Station 4]

The exposure/development station 4 includes an exposure unit 20 having a PLZT print head 20a, an exposure controller 21 for controlling the exposure unit 20, a development unit 22 for developing the print paper 2 which has been exposed by the exposure unit 20, a development controller 23 for controlling conveying of a print paper within the development unit 22 and managing developing solutions, a printer controller 24 for controlling this entire exposure/development station 4, and a print paper conveying system PT for conveying the print paper 2 drawn out of a print paper magazine 8 mounted on the top face of the housing to the development unit 22 by means of e.g. a plurality of conveying rollers 25.

Outside the housing of the exposure/development station 4, as shown in FIG. 2, there are provided a sorter 26 for sorting print papers 2 developed and dried at the development unit 22 according to each customer's order and a conveyer 27 for conveying each print paper 2 discharged from a discharge opening 22a of the development unit 22 to the sorter 26.

Further, at mid positions in the conveying path of the print paper conveying system PT, there are provided a cutter 28 for cutting the elongate print paper 2 drawn out of the print paper magazine 8 into a predetermined print size and a back printer 29 for printing predetermined information on the back face of the print paper 2. When a photographic print is to be made based on an image (data) stored in a memory card, the back printer 29 prints a file name of the image data stored in that memory card.

[Operation for Making Photographic Print]

Next, a series of operations for making a photographic print by the photographic printing system DP having the above-described construction will be schematically explained.

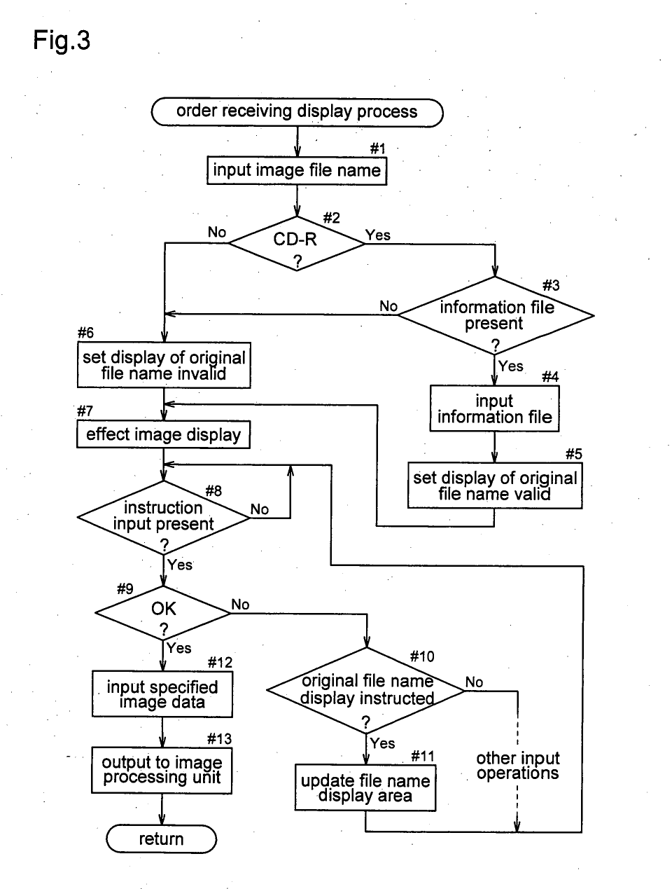

First, an operation for inputting the image data and other data upon receipt of a customer's print order will be explained with reference to the flowchart of FIG. 3.

The customer can place his/her print order by operating the print order receiver unit IR by himself or herself as described hereinbefore. Needless to say, the customer can place such order in the conventional manner also by giving a memory card, a photographic film or CD-R medium to an operator of the photographic printer PR or to a photo shop attendant.

The process illustrated in FIG. 3 is effected by the controller included in the print order receiver unit IR in case the customer places a print order by operating by himself or herself one of the print order receiver units IR mounted on the counter 100. Whereas, in case an operator inputs the print order by setting e.g. a memory card to the external input/output device 11, the process is effected by the main controller 12 of the management station 3.

As described hereinbefore, in this embodiment, the memory cards, the CD-R medium and the magneto-optic disk are described as the examples of the image storage media capable of storing therein images for making photographic prints. For the purpose of simplicity of explanation, however, the process illustrated in FIG. 3 is based on an assumption that image data for making photographic prints are inputted from a memory card or from a CD-R.

Therefore, in this embodiment, the print order receiver unit IR and the external input/output device 11 each functions as an input unit CT for inputting image data for making photographic prints.

Referring to the case of the operation being effected by an operator, the operator will set a memory card or a CD-R storing image data therein and brought in by a customer to a predetermined position of the external input/output device 11 and instruct start of operation via the operation console 12b. Then, the process shown in FIG. 3 will be initiated.

Namely, first, file name information of the image file stored in the set medium is inputted (step #1). If this medium is identified as a CD-R medium (step #2), the process checks whether a predetermined “information file” is present in this CD-R medium or not (step #3).

As will be detailed later, the predetermined “information file” described above refers to a file which was used to storing therein a file name (to be referred to as “original file name” hereinafter) of the image file stored in a memory card (an example of “image storage medium”) set in e.g. a digital camera used in the photography, when its photographic print was made based on that image file. This information file stores therein the file name of the image file as recorded in the CD-R together with and in correlation with the original file name as stored in the memory card. Therefore, the presence of this “information file” means that a reprint is being now ordered for a same image which was previously provided to the customer as image data in the form of the CD-R medium together with its photographic print thereof.

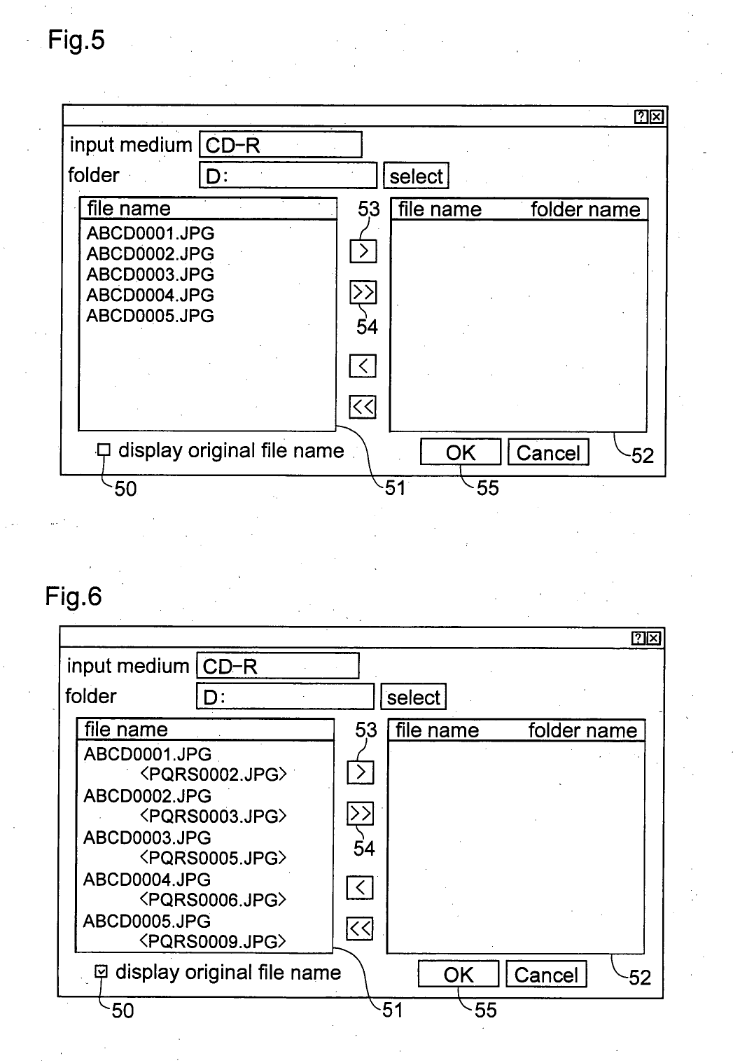

If it is determined that the CD-R medium records therein the information file (step #3), the process inputs data of this information file (step #4) and effects setting for rendering display of the original file name valid (step #5) and causes the monitor 12a to display a window shown in FIG. 5 for allowing specifying image files from which photographic prints (reprints) are to be made (step #7).

With the setting at step #5 for rendering the display of the original file name valid, in the window display shown in FIG. 5, a check box 50 corresponding to a character string “display original file name” is set ready for accepting an input operation (e.g. a mouse click operation) for placing a check mark therein.

On the other hand, if it is determined that the medium (image storage medium) set to the external input/output device 10 is not a CD-R but a memory card (step #2) or if it is determined that the medium is a CD-R but no “information file” is present therein (step #3), then, the process effects setting for rendering display of the original file name invalid (step #6) and causes the monitor to display a window similar to the one shown in FIG. 5 (step #7).

The above-described setting for rendering display of the original file name invalid specifically refers to setting for making the check box 50 inoperable to accept the input operation for placing a check mark therein.

The window screen of the monitor 12a shown in FIG. 5 includes a printing candidate file display column 51 for displaying a list of file names (inputted at step #1) of image files recorded in the medium set to the external input/output device 11, a printing specified file display column 52 for displaying a list of image file(s) which have (has) been specified from the image files displayed at the printing candidate file display column 51 to be processed into photographic prints, a printing select button 53 for selecting each file name from those displayed at the printing candidate file display column 51 to be copied to the printing specified file display column 52, an all-select button 54 used for selecting all the file names list-displayed at the printing candidate file display column 51 to be copied at one time to the printing specified file display column 52, a decision button 55 for receiving an instruction of deciding making photographic prints of the files list-displayed at the printing specified file display column 52, and other buttons having other various functions.

While the monitor 12a is displaying the window of FIG. 5, if the operator effects an input operation by means of e.g. a mouse (not shown) for placing a check mark at the check box 50 (steps #8, #10), then, as shown in FIG. 6, the printing candidate file display column 51 displays the original file name (i.e. the file name of the image file which stored in e.g. a memory card of a digital camera) within a < > in correlation with or paired with its image file name used in the CD-R medium (step #11).

Hence, when receiving a reprint order by way of customer's specification of the original file name, the operator can identify each image file to be processed into a photographic print with reference to the display of its original file name. Then, when the operator selects the identified image file and then clicks the print select button 53, the image file or a list of image files to be processed into a photographic print(s) is displayed at the printing specified file display column 52.

When the operator completes selection of all image files to be made into photographic prints and operates the decision button 55 in the display of FIG. 5 or the like (steps #8, #9), the process inputs the image files listed at the printing specified file display column 52 from the medium set to the external input/output device 11 (step #12) and transmits these files together with their image file names to the image processing apparatus of the main controller 12 (step #13).

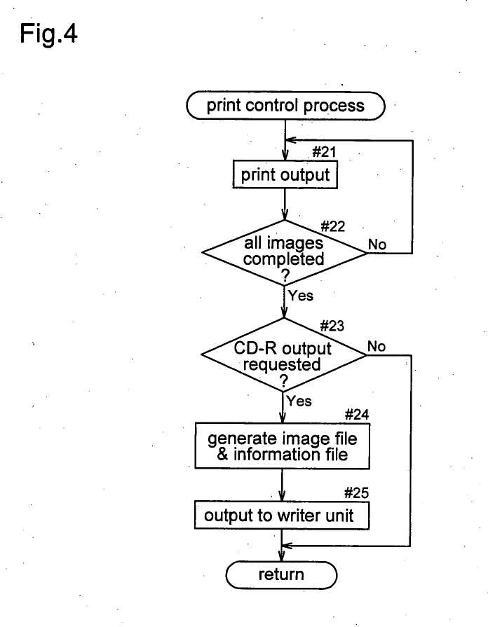

Next, with reference to a flowchart of FIG. 4, there will be described the operation of the main controller 12 after receiving the image data of each frame image and other order condition data associated therewith.

With the photographic printer PR, a skilled operator can effect a color adjustment operation with high precision by using a simulated image displayed on the monitor 12a. Upon completion of this operation, the subsequent operation shown in FIG. 4 is initiated.

First, the image data received from the external input/output device 11 or the print order receiver unit IR are outputted one after another for respective frame images to the exposure/development station 4 to be printed on print papers 2 (step #21). In the course of this, the image file names of the respective image data are also outputted to the exposure/development station 4.

Then, at the exposure/development station 4, the back printer 29 prints each received image file name on the back face of a corresponding print paper 2.

Upon completion of output of all image data (step #22), in case there has issued an instruction for recording and storing the image data of the image processed into photographic prints in a CD-R medium (step #23), the process generates the “information file” which contains both the image file names in the medium based on which the photographic prints were made (i.e. the file names inputted at step #1 of FIG. 3 and printed on the back sides of the photographic prints) and the file names of the image file to be written into the CD-R medium in correlation with each other. The process further compiles the image data of each frame image into an image file of a standard format such as JPEG (step #24) and outputs both the information file and this image file to the CD-R writer CR (step #25). Upon receipt of the information file and the image file as separate files, the CD-R writer CR writes these files under a standard format such as DCF (Design rule for Camera File system) into the set CD-R medium.

The information file prepared as above will be used in the process subsequent to step #3 in FIG. 3, so that when a reprint order has been placed with the CD-R medium including this information file, the operation for identifying image files to be reprinted can be effected easily.

The above discussion concerns the case where image data to be processed into photographic prints are inputted via the external input/output device 11 by the operator according to a customer's order. The same operations will be effected when a customer places a print order by self-operating the print order receiver unit IR.

The image data for exposure transmitted from the management station 3 to the exposure/development station 4 as described above will be stored in a memory incorporated in the printer controller 24 of the exposure/development station 4.

Upon detection of conveyance of a front end of the print paper 2 to a predetermined exposure start position based on conveyance information on the print paper 2 transmitted from the print paper conveying system PT, the printer controller 24 instructs the exposure controller 21 to start an exposure operation and sequentially transmits exposure image data to the exposure controller 21 at a speed corresponding to an exposing speed of the exposure unit 20.

Then, the exposure controller 21 activates the respective optical shutters of the PLZT print head 20a based on the received exposure image data, thereby to form a latent image of the print image on the print paper 2.

The print paper 2 exposed at the exposure unit 20 is then conveyed by the print paper conveying system PT to the development unit 22, in which the paper is developed as it is caused to pass respective development solution tanks. Thereafter, the developed print paper 2 is dried and then discharged from the discharge opening 22a onto the conveyer 27 and sorted by the sorter 26 according to each customer's order.

### Other Embodiments

Next, other embodiments of the invention will be described.

(1) In the foregoing embodiment, the file name (original file name) of the image data corresponding to the image to be written into the CD-R medium (recording medium) and given when stored in the original medium (i.e. the image storage medium, mainly a memory card) is written as a file separate from the image file. However, in case the file format of the image file to be written into a CD-R medium is a format which allows writing of desired comments, the original file name may be stored as a portion of the data of the image file.

(2) In the main discussion of the foregoing embodiment, photographic prints are made from a memory card in which image data were recorded as files by e.g. a digital camera and these image files and their information files were stored together in a CD-R medium. Then, if a customer orders a reprint based on this CD-R medium, the operator can specify images to be reprinted with reference to the original file names thereof recorded in that CD-R medium. However, the present invention can be used when various types of media are employed, such as when photographic prints are to be made based on image data stored in a magneto-optical disk as the image storage medium.

(3) In the foregoing embodiment, the CD-R medium as an example of non-rewritable recording media was employed as a recording medium to be written by the writing device, i.e. the CD-R writer CR. Instead, other types of recording medium such as a DVD-R or a magneto-optic disk can be employed as well.

(4) In the foregoing embodiment, the photographic printer PR employs the exposure method using the PLZT optical shutter type having the PLZT print head 20a. In this invention, the exposure method is not limited thereto, but can be a laser exposure using a laser beam for scanning/exposure. Further, the printing method can be a non-exposure printing method such as the ink jet printing.

1. A photographic printing system comprising:
an input unit for inputting an image for making a photographic print thereof from an image storage medium storing the image in the form of an image file;
a photographic printer for making the photographic print based on the image inputted by the input unit; and
a writer unit for writing image data of the image from which the photographic print has been made, into a recording medium;
wherein said writer unit writes into the recording medium a file name assigned to the image data when recorded in the image storage medium, either as an information file separate from and in correlation with said image file or as a portion of the data of said image file.

2. The photographic printing system according to claim 1, wherein said recording medium comprises a CD-R medium.

3. A method of making a photographic print, comprising the steps of:
inputting an image for making a photographic print thereof from an image storage medium storing the image in the form of an image file;
making the photographic print based on the image inputted by an input unit; and
writing image data of the image from which the photographic print has been made, into a recording medium;
wherein at said writing step, a file name assigned to the image data when recorded in the image storage medium is written in the recording medium either as an information file separate from and in correlation with said image file or as a portion of the data of said image file.
